(19) United States
(12) Patent Application Publication
(10) Pub. No.: US 2006/0274766 A1
(43) Pub. Date: Dec. 7, 2006

(54) Smart intermediate authentication management (SIAM) system and method for multiple permanent virtual circuit (PVC) access environment

(76) Inventor: Il-Won Kwon, Ansan-si (KR)

Correspondence Address: Robert E. Bushnell, Suite 300, 1522 K Street, N.W., Washington, DC, 20005, US

(21) Appl. No.: 11/404,852

(22) Filed: Apr. 17, 2006

(30) Foreign Application Priority Data
Jun. 2, 2005 (KR) 10-2005-0047385

(51) Int. Cl. H04L 12/56

(52) U.S. Cl. 370/401; 713/168

(57) ABSTRACT

A Smart Intermediate Authentication Management (SIAM) system and method for a multiple Permanent Virtual Circuit (PVC) access environment can be applied to both a Point to Point over Ethernet (PPPoE) session and a Dynamic Host Configuration Protocol (DHCP) session when a variety of services are provided to one subscriber using a number of Permanent Virtual Circuits (PVCs). The system includes an authentication module for classifying types of authentication sessions according to an authentication initiation packet received from a multimedia service subscriber through a multiple PVC, identifying whether Media Access Control (MAC) address information of a service subscriber for which authentication is requested has been registered, and determining whether to authenticate the service subscriber.

### CLAIM OF PRIORITY

This application makes reference to, incorporates the same herein, and claims all benefits accruing under 35 U.S.C. §119 from an application for SMART INTERMEDIATE AUTHENTICATION MANAGER SYSTEM AND METHOD FOR MULTIPLE PERMANENT VIRTUAL CIRCUIT ACCESS ENVIRONMENT earlier filed in the Korean Intellectual Property Office on the 2^{nd} of June 2005 and there duly assigned Serial No. 10-2005-0047385.

### BACKGROUND OF THE INVENTION

1. Field of the Invention

The present invention relates to a Smart Intermediate Authentication Management (SIAM) system and method for a multiple Permanent Virtual Circuit (PVC) access environment, and more particularly, to an SIAM system and method, which can be applied to both a Point to Point over Ethernet (PPPoE) session and a Dynamic Host Configuration Protocol (DHCP) session when a variety of services are provided to one subscriber using a number of Permanent Virtual Circuits (PVCs).

2. Description of the Related Art

A Broadband Integrated Services Digital Network (B-ISDN) requires a transmission speed requested by various types of information and a transmission technology which can actively meet such services and in which a network structure does not depend on a transmission speed or a property of information. In such a transmission technology, two transmission modes of circuit and packet schemes are widely used. The circuit mode has a drawback in that it has a low circuit usage rate, and it is not easy to add services and it is not possible to efficiently use network resources since the mode is based on a synchronous time slot for multiplexing.

Furthermore, in the packet mode, since most of protocols are consumed in communication processing, it is not efficient for actual information transmission and is difficult to transmit information in real time. Accordingly, there is a need for a technology to supplement drawbacks of the circuit and packet modes. A scheme to meet such a situation is an Asynchronous Transfer Mode (ATM).

Such an ATM scheme has long been settled as a core technology for Broadband Integrated Services Digital Network (B-ISDN) which is a next generation information network because of its advantage of accommodating all future multimedia services in a single network. A basic unit of information transmission is defined as a packet having a fixed size, that is, a cell, and the cells are transmitted through a virtual circuit.

Especially, the ATM scheme can provide both a Switched Virtual Circuit (SVC) and a Permanent Virtual Circuit (PVC), accommodate high definition images as well as voice, and provide a variety of interfaces for a high speed WAN communication network.

Accordingly, users can be provided with a variety of multimedia services through a SVC connection and a PVC connection.

The switched virtual circuit connection is made when a signaling entity of a user terminal requires the ATM network to set up the connection. A main user can be a general user who wishes to use the ATM service for a short time.

The PVC connection is made when the user requires an operator of the ATM network to set up the connection by making a phone call directly.

That is, in the PVC, a communication path to a pre-designated counterpart is permanently established, not requiring establishment/release of the communication path. The communication path does not occupy a bandwidth when transmitting no data even though using the PVC since the path is not a physical path.

In services using a Home GateWay (HGW), a connection terminal for simple Internet service and a connection terminal for video service are generally provided. Especially, the connection terminal for video service is connected to a Set-Top-Box (STB) and delivers a video signal to a TV.

Recently, when the HGW is provided with a plurality of PVCs in order to provide one subscriber with a variety of services, PPPoE session authentication is necessary for a simple Internet connection or DHCP authentication is necessary when IP based multicasting, such as an Internet Protocol TeleVision (IPTV) service, is required according to a policy of a company. In the conventional subscriber authentication, however, the PPPoE subscriber authentication and the DHCP subscriber authentication are separately performed.

That is, the PPPoE subscriber authentication for simple Internet service comprises a discovery stage for connection, a PPP session stage in which a client transmits and receives data by making a connection to a desired site over Internet, and a discovery stage for terminating a connection between the client and a server (the PPPoE standard is defined in RFC2516).

Furthermore, since the DHCP subscriber authentication for the IP based multimedia service uses a client/server model in which an IP address used in the network is managed in a central concentration manner by the DHCP server, the DHCP support client can request an IP address to the DHCP server and obtain it in the process of network booting (DHCP standard is defined in RFC 2131).

However, in the case of a conventional subscriber access environment, since the HGW which utilizes a plurality of PVCs and a variety of service provision environments using such a HGW are not considered, it is not possible to prevent a malicious user from using the service session. That is, there is no method for integrally managing the PPPoE session and DHCP session in the access environment using the plurality of PVCs.

In other words, a connection terminal for a video service of the HGW has to guarantee high data transmission. To do this, a quality of the PVC should be guaranteed over a predetermined level in the network section and thus it requires a relatively high cost.

PVC is likely to be illegally used for an unauthorized STB or an unauthorized Internet data service because of its high quality of service. The conventional DHCP session authentication does not provide perfect authentication in an HGW environment having various types of connected terminals because only subscriber connection line information (Port ID) is additionally transmitted.

Furthermore, the PPPoE session authentication for Internet access needs to additionally deliver ID information of the subscriber line to the authentication server in the discovery stage because there is no information indicating which session requests an IP in an environment where one subscriber is provided with a plurality of PVCs.

### SUMMARY OF THE INVENTION

It is, therefore, an object of the present invention to provide a Smart Intermediate Authentication Management (SIAM) system and method, which can be applied to both a Point to Point over Ethernet (PPPoE) session and a Dynamic Host Configuration Protocol (DHCP) session when a variety of services are provided to one subscriber using a number of Permanent Virtual Circuits (PVCs).

According to an aspect of the present invention, a multimedia service subscriber authentication system for a multiple Permanent Virtual Circuit (PVC) access environment is provided, the system including: an authentication module adapted to: classify types of authentication sessions according to an authentication initiation packet received from a multimedia service subscriber through a multiple PVC; determine whether Media Access Control (MAC) address information of a service subscriber for which authentication is requested is registered; and determine whether to authenticate the service subscriber.

The authentication module is preferably included in either an Access GateWay (AGW) or a Digital Subscriber Line Access Multiplexer (DSLAM).

The system further includes an authentication server adapted to assign an Internet Protocol (IP) address to the service subscriber upon receipt of the authenticated authentication initiation packet from the authentication module.

The authentication module preferably further includes: an authentication session identifier adapted to determine the types of authentication sessions according to the authentication initiation packet received from the multimedia service subscriber; a source information storage unit adapted to store source information to authenticate the multimedia service subscriber; and an authentication controller adapted to approve intermediate authentication for the service subscriber upon the MAC address information of the service subscriber for which authentication is requested has been registered in the source information storage unit according to the types of the authentication sessions determined by the authentication session identifier.

The authentication session identifier is preferably adapted to recognize a Dynamic Host Configuration Protocol (DHCP) session authentication upon the authentication initiation packet being a DHCP request packet and to recognize a Point to Point over Ethernet (PPPoE) session authentication upon the authentication initiation packet being a PPPoE request packet.

The source information storage unit preferably includes at least one of port information of a Home GateWay (HGW) connected to the multimedia service subscriber line, multiple PVC information, service type information, and MAC address information.

The authentication controller is preferably adapted to approve the intermediate authentication for the service subscriber upon port information of the service subscriber for which authentication is requested and MAC address information corresponding to PVC information being registered in the source information storage unit, and upon the type of authentication session determined by the authentication session identifier being the DHCP session authentication.

The authentication controller is preferably adapted to identify the port information and the PVC information of the service subscriber for which authentication is requested, to identify the MAC address of the authentication initiation packet, and to approve the intermediate authentication for the service subscriber, upon the type of authentication session identified by the authentication session identifier being the PPPoE session authentication.

According to another aspect of the present invention, a multimedia service subscriber authentication system for a multiple Permanent Virtual Circuit (PVC) access environment is provided, the system including: an authentication session identifier adapted to determine types of authentication sessions according to an authentication initiation packet received from a multimedia service subscriber; a source information storage unit adapted to store source information to authenticate the multimedia service subscriber; and an authentication controller adapted to approve intermediate authentication for the service subscriber upon Media Access Control (MAC) address information of the service subscriber for which authentication is requested being registered in the source information storage unit according to the authentication session determined by the authentication session identifier.

The authentication session identifier is preferably adapted to recognize a Dynamic Host Configuration Protocol (DHCP) session authentication upon the authentication initiation packet being a DHCP request packet, and to recognize a Point to Point over Ethernet (PPPoE) session authentication upon the authentication initiation packet being a PPPoE request packet.

The source information storage unit preferably includes at least one of port information of a Home GateWay (HGW) connected to the multimedia service subscriber line, multiple PVC information, service type information, and MAC address information.

The authentication controller is preferably adapted to approve the intermediate authentication for the service subscriber upon the port information of the service subscriber for which authentication is requested and the MAC address information corresponding to PVC information being registered in the source information storage unit and upon the type of the authentication session identified by the authentication session identifier being the DHCP session authentication.

The authentication controller is preferably adapted to identify the port information and the PVC information of the service subscriber for which authentication is requested, to identify the MAC address of the authentication initiation packet, and to approve the intermediate authentication for the service subscriber upon the type of the authentication session identified by the authentication session identifier being the PPPoE session authentication.

According to still another aspect of the present invention, a multimedia service subscriber authentication method for a multiple Permanent Virtual Circuit (PVC) access environment is provided, the method including: classifying types of authentication sessions according to an authentication initiation packet received from a multimedia service subscriber through a multiple PVC; and identifying whether Media Access Control (MAC) address information of a service subscriber for which authentication is requested has been registered according to the classified types of authentication sessions to determine whether to authenticate the service subscriber.

Identifying whether Media Access Control (MAC) address information of a service subscriber for which authentication is requested has been registered preferably further includes approving the authentication for the service subscriber upon the MAC address information corresponding to the port information and the PVC information of the service subscriber for which authentication is requested being registered in the source information storage upon the authentication session type being a Dynamic Host Configuration Protocol (DHCP) session authentication.

Identifying whether Media Access Control (MAC) address information of a service subscriber for which authentication is requested has been registered preferably further includes identifying the port information and the PVC information of the service subscriber for which authentication is requested, and approving the authentication for the service subscriber by identifying the MAC address of the authentication initiation packet upon the authentication session type being a Point to Point over Ethernet (PPPoE) session authentication.

Approving the authentication for the service subscriber by identifying the MAC address of the authentication initiation packet preferably further includes: identifying source MAC address information of a PPPoE Active Discovery Initiation (PADI) packet received from the service subscriber, and transmitting a PPPoE Active Discovery Offer (PADO) packet to the service subscriber; and identifying the source MAC address information of a PPPoE Active Discovery Request (PADR) packet received from the service subscriber, and transmitting a PPPoE Active Discovery Session-confirmation (PADS) packet to the service subscriber.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings in which like reference symbols indicate the same or similar components, wherein:

FIG. 1 is a block diagram of a Smart Intermediate Authentication Management (SIAM) system for a multiple Permanent Virtual Circuit (PVC) access environment in accordance with an exemplary embodiment of the present invention;

FIG. 2 is a block diagram of an SIAM module of the AGW of FIG. 1;

FIG. 3 is a table of a session initiation packet source information DB of FIG. 2; and

FIG. 4 is a flowchart of an intermediate authentication management method for a multiple PVC access environment in accordance with an exemplary embodiment of the present invention.

### DETAILED DESCRIPTION OF THE INVENTION

Hereinafter, exemplary embodiments of the present invention are described in detail below with reference to the accompanying drawings. In the following description, a detailed description of known functions and configurations incorporated herein has been omitted for conciseness.

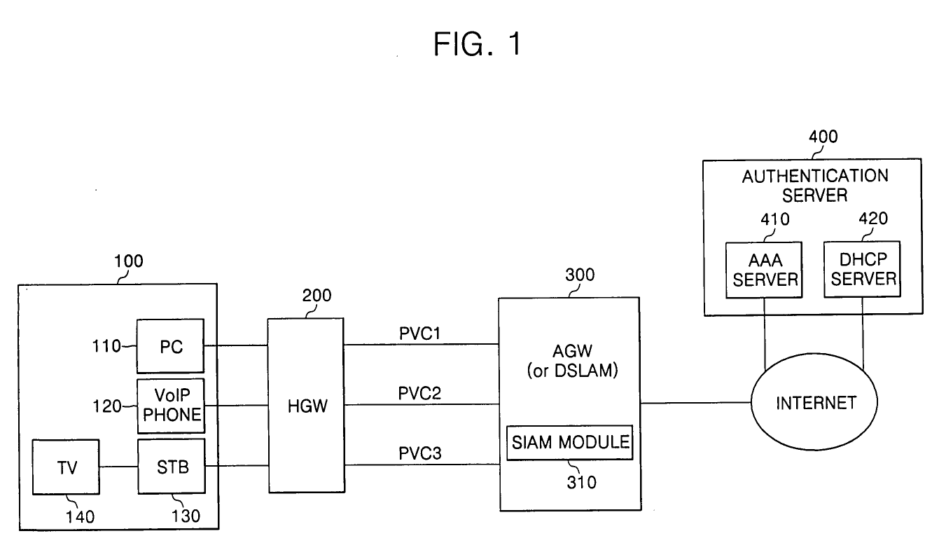

FIG. 1 is a block diagram of a Smart Intermediate Authentication Management (SIAM) system for a multiple Permanent Virtual Circuit (PVC) access environment in accordance with an exemplary embodiment of the present invention.

Referring to FIG. 1, the system according to the present invention includes a subscriber terminal 100 for receiving a variety of multimedia services, a Home GateWay (HGW) 200 connected to the subscriber terminal 100, an Access GateWay (AGW) 300 connected to a HGW 200 through multiple PVCs, and an authentication server 400 connected to the AGW 300 over the Internet for performing a final authentication function on clients.

The subscriber terminal 100 includes terminals for receiving general Internet services and IP based multimedia services.

That is, the terminal for receiving Internet services can be a general computer 110 having a LAN card used to access the Internet, and the terminals for receiving the IP based multimedia service can be an IP based Voice over Internet Protocol (VoIP) phone 120 and a Set-Top-Box (STB) 130 used to receive an IPTV broadcast.

Especially, the STB 130 is connected to a TV 140 with which a viewer can watch the received IPTV broadcast.

The HGW 200 is a gateway which enables users of the subscriber terminal 100 to receive a variety of IP based multimedia services as well as simple Internet services, including different ports for different services.

That is, a LAN card of the computer 110 in the subscriber terminal 100 is connected to the LAN card connection port of the HGW 200 to receive simple Internet services, and the VoIP phone 120 and the STB 130 that are used to receive a variety of IP based multimedia services are respectively connected to a VoIP phone connection port and an STB connection port.

The AGW 300 is connected to the HGW 200 through the multiple PVCs. Especially, a first PVC (PVC 1) in FIG. 1 is used to provide simple Internet services, a second PVC (PVC 2) is used to provide IP based VoIP services, and a third PVC (PVC 3) is used to provide an IPTV broadcast service.

Such an AGW 300 in accordance with the present invention includes an SIAM module 310 which is used to perform a management task for an effective authentication of a service subscriber between a subscriber client and the authentication server 400. Such an SIAM module 310 is described below in more detail.

Of course, the AGW 300 can use a Digital Subscriber Line Access Multiplexer (DSLAM) which performs the same function.

The authentication server 400 is generally comprised of an Authentication, Authorization, Accounting (AAA) server 410 for authenticating the service subscriber when an Internet service is requested, and a DHCP server 420 for authenticating the service subscriber when the IP based multimedia service is requested.

The authentication function of the AAA server 410 is to approve an identity of the user who wishes to use the network, and an authorization function is to endow a user whose identity is approved with an authorization defined in advance and to assign a network resource according to the authorization. Furthermore, an accounting function is to record and manage the amount of used services in order to charge the user.

That is, the AAA server 410 authenticates the service subscriber and endows the authenticated service subscriber with IP assignment so that the user can use the Internet service.

Furthermore, the DHCP server 420 simply assigns the IP only without authenticating the service subscriber, unlike the AAA server 410, and enables the user to use the IP based multimedia service.

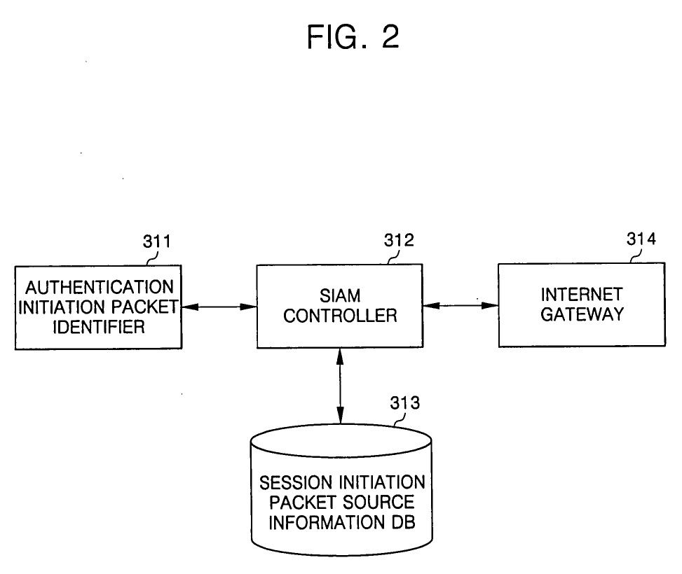

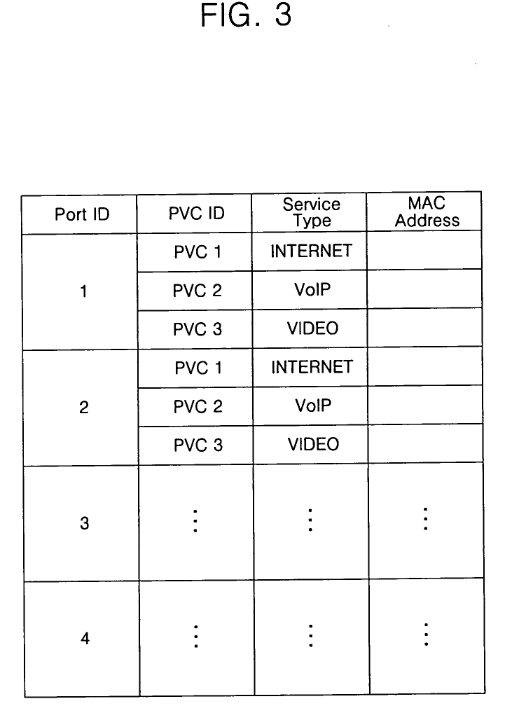

FIG. 2 is a block diagram of an SIAM module of the AGW of FIG. 1, and FIG. 3 is a table of a session initiation packet source information DB of FIG. 2.

As shown in FIG. 2, the SIAM module 310 according to the present invention performs a function to effectively authenticate a service subscriber between a subscriber client and an authentication server.

Such an SIAM module 310 according to the present invention includes an authentication initiation packet identifier 311, a SIAM controller 312, a session initiation packet source information DB 313, and an Internet gateway 314.

The authentication initiation packet identifier 311 identifies an authentication initiation packet received from the service subscriber terminal 100 through the HGW 200 and then identifies the type of authentication session. The authentication initiation packet can be divided into a DHCP request packet and a PPP request packet.

That is, when the authentication initiation packet received from the subscriber terminal 100 is identified as a DHCP request packet, the authentication initiation packet identifier 311 identifies DHCP session authentication for subscriber authentication of the IP based multimedia service. On the other hand, when the authentication initiation packet received from the subscriber terminal 100 is identified as a PPP request packet, the authentication initiation packet identifier 311 identifies PPPoE session authentication for the subscriber authentication of the Internet service.

If the authentication initiation packet identifier 311 identified that the type of the authentication session requested from the service subscriber is the DHCP session authentication, then the SIAM controller 312 identifies a port ID and a PVC ID with which DHCP session authentication is requested.

Then, the SIAM controller 312 determines whether the identified PVC is for video or VoIP. If the PVC is for video, the SIAM controller 312 identifies and stores device information of the STB and MAC address information.

That is, the SIAM controller 312 retrieves the session initiation packet source information DB 313 to determine whether or not the device information of the STB and the MAC address information are registered.

If the device information and the MAC address information of the STB are registered in the session initiation packet source information DB 313, then the SIAM controller 312 transmits the identified authentication initiation packet (DHCP request packet) to the authentication server 400 over the Internet gateway 314.

Accordingly, the DHCP server 420 of the authentication server 400 receives the identified authentication initiation packet (DHCP request packet) from the SIAM module of the AGW and assigns IP through final authentication, so that the corresponding client can receive a desired video service.

In this manner, by performing an intermediate authentication process of determining whether the device information of the STB and the MAC address information are registered in the session initiation packet source information DB 313 before requesting the IP assignment to the DHCP server 420 of the authentication server 400, it is possible to prevent illegal use of an unauthorized STB and other devices (e.g., PC).

Furthermore, the SIAM controller 312 identifies and stores an MAC address of the VoIP device when the identified PVC is for VoIP.

That is, the SIAM controller 312 retrieves the session initiation packet source information DB 313 to determine whether or not the MAC address information of the VoIP device is registered.

If the MAC address information of the VoIP device is registered in the session initiation packet source information DB 313, then the SIAM controller 312 transmits the identified authentication initiation packet (DHCP request packet) to the authentication server 400 through the Internet gateway 314.

Accordingly, the DHCP server 420 of the authentication server 400 receives the identified authentication initiation packet (DHCP request packet) from the SIAM module of the AGW and performs IP assignment through a final authentication step, so that the corresponding client can receive a desired VoIP service.

Meanwhile, if the authentication initiation packet identifier 311 determines that the type of authentication session requested by the service subscriber is PPPoE session authentication, then the SIAM controller 312 identifies the port ID with which PPPoE session authentication is requested and the PVC ID, and then identifies and stores a source MAC address of a PPPoE Active Discovery Initiation (PADI) packet which the client transmits for initiation.

Then, the SIAM controller 312 transmits the identified PADI packet to the authentication server 400 through the Internet gateway 314.

Among the servers receiving the PADI packet, a server which can provide a connection transmits the PPPoE Active Discovery Offer (PADO) packet to the client.

That is, since the SIAM controller 312 manages and identifies the port ID and PVC ID that requested the PADI packet on the basis of the MAC address, it is unnecessary to discriminate the subscriber session through additional transmission of the subscriber information (port ID or PVC ID) to the authentication server 400.

In response to receiving the PADO packet, the client transmits a Pppoe Active Discovery Request (PADR) packet in order to request a connection. Even in this case, the SIAM controller 312 identifies and stores the port ID and PVC ID for which authentication is requested, and then identifies a source MAC address of the PADR packet to transmit the PADR packet to the authentication server 400.

In response to receiving the PADR packet, the authentication server 400 transmits the PPPoE Active Discovery Session-confirmation (PADS) packet to the client in order to complete connection establishment.

In a subsequent PPP session step, the SIAM controller 312 identifies the PPP request packet received from the client and transmits it to the authentication server 400.

Upon receipt of the identified PPP request packet, the authentication server 400 assigns IP to the client through the final authentication step, so that the corresponding client can receive a desired Internet service.

The session initiation packet source information DB 313 manages source information of the session initiation packet for an authentication of the device at the Internet and IP multimedia service subscriber side. A table of such a DB is described below in greater detail with reference to FIG. 3.

As shown in FIG. 3, the source information of the session initiation packet includes information such as port ID, PVC ID, service type, and MAC address. This information is stored in a table format.

In other words, the port ID and PVC ID are managed on the basis of the MAC address for a device at the Internet and IP multimedia service subscriber side.

The Internet gateway 314 is a gateway for connection to the Internet network, which transmits packets communicated between the client and the authentication server.

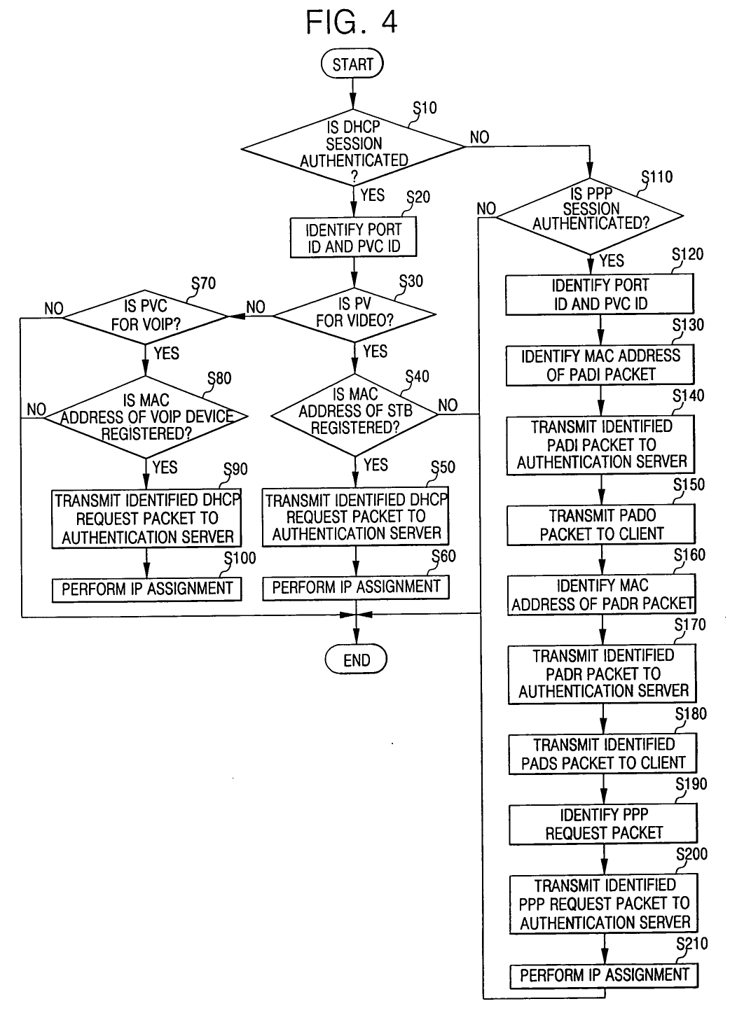

FIG. 4 is a flowchart of an intermediate authentication management method for a multiple PVC access environment in accordance with an exemplary embodiment of the present invention.

Referring to FIG. 4, an SIAM module according to the present invention identifies an authentication initiation packet received from the service subscriber terminal 100 through the HGW 200 to check the type of identifies authentication session.

Specifically, the SIAM module identifies whether the authentication initiation packet received from the subscriber terminal 100 is the DHCP request packet (S10). If the authentication initiation packet is the DHCP request packet, the SIAM module recognizes the authentication initiation packet as the DHCP session authentication for subscriber authentication of the IP based multimedia service and then identifies the port ID and PVC ID with which DHCP session authentication is requested (S20).

Subsequently, the SIAM module identifies whether the identified PVC is for video (S30). If the identified PVC is for video, the SIAM module identifies and stores the device information and MAC address information of the STB.

That is, the SIAM controller 312 retrieves the session initiation packet source information DB 313 to identify whether the device information and the MAC address information of the STB are registered (S40).

If the device information and the MAC address information of the STB are registered in the session initiation packet source information DB 313, the SIAM module transmits the identified authentication initiation packet (DHCP request packet) to the authentication server 400 through the Internet gateway 314 (S50).

Upon receipt of the identified authentication initiation packet (DHCP request packet) from the SIAM module of the AGW, the DHCP server 420 of the authentication server 400 performs IP assignment through a final authentication step (S60), so that the corresponding client can receive a desired video service.

However, when it has been determined in step S30 that the identified PVC is not for video, the SIAM module identifies whether the identified PVC is for VoIP (S70). When the identified PVC is for VoIP, the SIAM module identifies and stores the MAC address of the VoIP device.

That is, the SIAM module retrieves the session initiation packet source information DB 313 to identify whether the MAC address information of the VoIP device is registered (S80).

If the Media Access Control (MAC) address information of the VoIP device is registered in the session initiation packet source information DB 313, the SIAM module transmits the identified authentication initiation packet (DHCP request packet) to the authentication server 400 through the Internet gateway 314 (S90).

Upon receipt of the identified authentication initiation packet (DHC request packet) from the SIAM module of the AGW, the authentication server 400 performs the IP assignment through a final authentication step (S100), so that the corresponding client can receive a desired VoIP service.

When it has been determined in step S10 that the authentication initiation packet is not the DHCP request packet, the SIAM module identifies whether the authentication initiation packet is the PPP request packet (S110).

When the authentication initiation packet is the PPP request packet, the SIAM module recognizes it as the PPPeE session authentication for authenticating the Internet service subscriber, and identifies the port ID and PVC ID with which PPP session authentication is requested (S120).

The SIAM module then identifies a source MAC address of the PPPoE active discovery initiation (PADI) packet that the client transmits for initiation (S130).

Then, the SIAM module transmits the identified PPPoE active discovery initiation (PADI) packet to the authentication server 400 through the Internet gateway 314 (S140).

Among servers receiving the PADI packet, a server which can provide a connection transmits the PPPoE active discovery offer (PADO) packet to the client (S150).

In response to receiving the PADO packet, the client transmits the PPPoE active discovery request (PADR) packet in order to request a connection. Even in such a case, the SIAM module identifies and stores the port ID and PVC ID for which authentication is requested and then identifies the source MAC address of the PADR packet (S160) to transmit the PADR packet to the authentication server 400 (S170).

In response to receiving the PADR packet, the authentication server 400 transmits the PPPoE active discovery session-confirmation (PADS) packet to the client in order to complete the connection establishment (S180).

In a subsequent PPP session step, the SIAM module identifies the PPP request packet received from the client (S190), and then transmits it to the authentication server 400 (S200).

In response to receiving the identified PPP request packet, the authentication server 400 performs the IP assignment to the client through a final authentication step (S210), so that the corresponding client can receive a desired Internet service.

According to the present invention, it is possible to authenticate subscriber access for each service without significantly changing an existing authentication server by providing a smart intermediate authentication and security scheme which can be applied to both a Point to Point over Ethernet (PPPoE) session and a Dynamic Host Configuration Protocol (DHCP) session when a variety of services is provided to one subscriber using a number of Permanent Virtual Circuits (PVCs).

While the present invention has been described with reference to exemplary embodiments thereof, it will be understood by those skilled in the art that various modifications in form and detail can be made therein without departing from the scope of the present invention as defined by the following claims.

What is claimed is:

1. A multimedia service subscriber authentication system for a multiple Permanent Virtual Circuit (PVC) access environment, the system comprising:
an authentication module adapted to:
classify types of authentication sessions according to an authentication initiation packet received from a multimedia service subscriber through a multiple PVC;
determine whether Media Access Control (MAC) address information of a service subscriber for which authentication is requested is registered; and
determine whether to authenticate the service subscriber.

2. The system according to claim 1, wherein the authentication module is included in either an Access GateWay (AGW) or a Digital Subscriber Line Access Multiplexer (DSLAM).

3. The system according to claim 1, further comprising an authentication server adapted to assign an Internet Protocol (IP) address to the service subscriber upon receipt of the authenticated authentication initiation packet from the authentication module.

4. The system according to claim 1, wherein the authentication module further comprises:
an authentication session identifier adapted to determine the types of authentication sessions according to the authentication initiation packet received from the multimedia service subscriber;
a source information storage unit adapted to store source information to authenticate the multimedia service subscriber; and
an authentication controller adapted to approve intermediate authentication for the service subscriber upon the MAC address information of the service subscriber for which authentication is requested has been registered in the source information storage unit according to the types of the authentication sessions determined by the authentication session identifier.

5. The system according to claim 4, wherein the authentication session identifier is adapted to recognize a Dynamic Host Configuration Protocol (DHCP) session authentication upon the authentication initiation packet being a DHCP request packet and to recognize a Point to Point over Ethernet (PPPoE) session authentication upon the authentication initiation packet being a PPPoE request packet.

6. The system according to claim 4, wherein the source information storage unit comprises at least one of port information of a Home GateWay (HGW) connected to the multimedia service subscriber line, multiple PVC information, service type information, and MAC address information.

7. The system according to claim 5, wherein the authentication controller is adapted to approve the intermediate authentication for the service subscriber upon port information of the service subscriber for which authentication is requested and MAC address information corresponding to PVC information being registered in the source information storage unit, and upon the type of authentication session determined by the authentication session identifier being the DHCP session authentication.

8. The system according to claim 5, wherein the authentication controller is adapted to identify the port information and the PVC information of the service subscriber for which authentication is requested, to identify the MAC address of the authentication initiation packet, and to approve the intermediate authentication for the service subscriber, upon the type of authentication session identified by the authentication session identifier being the PPPoE session authentication.

9. A multimedia service subscriber authentication system for a multiple Permanent Virtual Circuit (PVC) access environment, the system comprising:
an authentication session identifier adapted to determine types of authentication sessions according to an authentication initiation packet received from a multimedia service subscriber;
a source information storage unit adapted to store source information to authenticate the multimedia service subscriber; and
an authentication controller adapted to approve intermediate authentication for the service subscriber upon Media Access Control (MAC) address information of the service subscriber for which authentication is requested being registered in the source information storage unit according to the authentication session determined by the authentication session identifier.

10. The system according to claim 9, wherein the authentication session identifier is adapted to recognize a Dynamic Host Configuration Protocol (DHCP) session authentication upon the authentication initiation packet being a DHCP request packet, and to recognize a Point to Point over Ethernet (PPPoE) session authentication upon the authentication initiation packet being a PPPoE request packet.

11. The system according to claim 9, wherein the source information storage unit comprises at least one of port information of a Home GateWay (HGW) connected to the multimedia service subscriber line, multiple PVC information, service type information, and MAC address information.

12. The system according to claim 10, wherein the authentication controller is adapted to approve the intermediate authentication for the service subscriber upon the port information of the service subscriber for which authentication is requested and the MAC address information corresponding to PVC information being registered in the source information storage unit and upon the type of the authentication session identified by the authentication session identifier being the DHCP session authentication.

13. The system according to claim 10, wherein the authentication controller is adapted to identify the port information and the PVC information of the service subscriber for which authentication is requested, to identify the MAC address of the authentication initiation packet, and to approve the intermediate authentication for the service subscriber upon the type of the authentication session identified by the authentication session identifier being the PPPoE session authentication.

14. A multimedia service subscriber authentication method for a multiple Permanent Virtual Circuit (PVC) access environment, the method comprising:
classifying types of authentication sessions according to an authentication initiation packet received from a multimedia service subscriber through a multiple PVC; and
identifying whether Media Access Control (MAC) address information of a service subscriber for which authentication is requested has been registered according to the classified types of authentication sessions to determine whether to authenticate the service subscriber.

15. The method according to claim 14, wherein identifying whether Media Access Control (MAC) address information of a service subscriber for which authentication is requested has been registered further comprises approving the authentication for the service subscriber upon the MAC address information corresponding to the port information and the PVC information of the service subscriber for which authentication is requested being registered in the source information storage upon the authentication session type being a Dynamic Host Configuration Protocol (DHCP) session authentication.

16. The method according to claim 14, wherein identifying whether Media Access Control (MAC) address information of a service subscriber for which authentication is requested has been registered further comprises identifying the port information and the PVC information of the service subscriber for which authentication is requested, and approving the authentication for the service subscriber by identifying the MAC address of the authentication initiation packet upon the authentication session type being a Point to Point over Ethernet (PPPoE) session authentication.

17. The method according to claim 16, wherein approving the authentication for the service subscriber by identifying the MAC address of the authentication initiation packet further comprises:
identifying source MAC address information of a PPPoE Active Discovery Initiation (PADI) packet received from the service subscriber, and transmitting a PPPoE Active Discovery Offer (PADO) packet to the service subscriber; and
identifying the source MAC address information of a PPPoE Active Discovery Request (PADR) packet received from the service subscriber, and transmitting a PPPoE Active Discovery Session-confirmation (PADS) packet to the service subscriber.
